(19) United States
(12) Patent Application Publication
(10) Pub. No.: US 2026/0211101 A1
(43) Pub. Date: Jul. 23, 2026

(54) SYSTEMS AND METHODS FOR DETECTING AIRBORNE INTRUSIONS USING SIGNALS FROM LOW EARTH ORBIT (LEO) SATELLITES

(71) Applicant: A2 Labs, LLC, Arlington, VA (US)

(72) Inventors: Ian Jordan BROWN, Arlington, VA (US); Alireza FAMILI, Arlington, VA (US); Angelos STAVROU, Fairfax, VA (US)

(73) Assignee: A2 Labs, LLC, Arlington, VA (US)

(21) Appl. No.: 19/251,554

(22) Filed: Jun. 26, 2025

Related U.S. Application Data
(60) Provisional application No. 63/748,855, filed on Jan. 23, 2025.

(51) Int. Cl. G01S 13/56; H04B 7/185; H04B 7/195

(52) U.S. Cl. CPC G01S 13/56; H04B 7/1855; H04B 7/195

(57) ABSTRACT

A system and method to detect airborne intrusions using a plurality of downlink signals from low Earth orbit (LEO) satellites is disclosed. The system includes an antenna, a signal processing unit, and a user. Further, the antenna captures a plurality of signals from at least one satellite within a predefined frequency band. The plurality of signals comprises downlink signals. The at least one satellite comprises a Low Earth Orbit (LEO) satellite. Further, the signal processing unit extracts a plurality of reference beacon tones from the captured plurality of signals by identifying frequency characteristics and modulation characteristics of the plurality of signals. Furthermore, the signal processing unit establishes at least one baseline reference signal for the captured plurality of signals using the extracted plurality of reference beacon tones.

### PRIORITY

The present patent application claims priority to U.S. provisional patent application Ser. No. 63/748,855 filed on Jan. 23, 2025, which is incorporated by reference in its entirety.

### TECHNICAL FIELD

This patent application is directed to detection systems and, more specifically, to systems and methods for detecting airborne intrusions using signals from Low Earth Orbit (LEO) satellites.

### BACKGROUND

Satellites must be precisely positioned in their designated orbits immediately after launch. These satellites move in a specific trajectory and serve various purposes, including commercial, military, and scientific applications. The orbits closest to Earth are referred to as Earth Orbits. The technological devices deployed in these orbits are classified as Low Earth Orbit (LEO) satellites.

One of the most extensively studied LEO-based passive radar systems is synthetic aperture radar, which utilizes the relative motion of satellites with respect to the ground to generate two-dimensional images of ground objects. However, synthetic aperture passive radar has several limitations, including the requirement for two receivers, one to capture the reference signal and another to capture the reflected signal as well as the necessity of high bandwidth due to range compression. Additionally, such radars may be incapable of detecting small targets, such as drones, with high resolution.

In contrast, forward scatter passive radar has significant potential for drone detection. Forward scatter is a phenomenon that occurs when an object passes directly through or near the line between a transmitter and a receiver. This phenomenon results in the radar cross-section (RCS) of the object appearing much larger than its actual RCS, making forward scatter radar highly effective for drone detection. However, until now, Starlink satellites have been primarily used for synthetic aperture passive radar. Therefore, analyzing Starlink in this context may provide insights into the feasibility of utilizing its downlink for forward scatter applications.

In a forward scatter geometry, when a drone approaches the baseline, the line connecting the transmitter and receiver, a Doppler shift is observed in the downlink due to the drone's velocity relative to the baseline. As the drone nears the baseline, the Doppler shift approaches zero, making the forward scatter effect more prominent. Notably, while the drone must be in proximity to the baseline for detection, it is not required to pass directly through it.

Furthermore, in a basic wireless communication channel, a simple drop in signal strength may indicate the presence of a drone within the link. However, in more complex and realistic environments, the forward scatter effect may be leveraged, where the movement of a drone through the link induces a Doppler shift. Additionally, the rotation of drone propellers generates micro-Doppler effects, which may be used to classify the object as a drone and potentially distinguish between different drone models.

To apply the advancements of LEO-based synthetic aperture passive radar to forward scatter drone detection, a phased array may be utilized to track individual satellites across the sky, ensuring a high signal-to-noise ratio (SNR). However, such equipment tends to be bulky and costly. Moreover, one existing system has identified that tones with a 200 kHz offset from a channel center are less likely to interfere with a local oscillator due to self-mixing effects.

Existing systems have demonstrated the passive radar capability of LEO satellites by employing synthetic aperture passive radar for ground-based object detection. Additionally, forward scatter passive radar has been successfully utilized for drone detection, though primarily in conjunction with geosynchronous equatorial orbit (GEO) satellites. The logical integration of these approaches appears to necessitate the use of phased array technology to track LEO satellites. While prior implementations have predominantly relied on parabolic dish or phased array antennas with gains exceeding 30 dBi, there is a possibility of capturing the required signals above the noise floor using a lower-gain horn antenna, given the limited bandwidth of interest.

Consequently, there is a recognized need for a system and method that employs a static antenna to effectively receive beacon signals from multiple LEO satellites simultaneously for localization purposes, thereby addressing at least the aforementioned challenges.

### SUMMARY

This summary is provided to introduce a selection of concepts, in a simple manner, which is further described in the detailed description of the disclosure. This summary is neither intended to identify essential inventive concepts of the subject matter nor to determine the scope of the disclosure.

An aspect of the present disclosure provides a system to detect airborne intrusion using signals from low Earth orbit (LEO) satellites. The system includes an antenna, a signal processing unit, and a user device. Further, the antenna captures a plurality of signals from at least one satellite within a predefined frequency band. The plurality of signals comprises downlink signals. The at least one satellite comprises a Low Earth Orbit (LEO) satellite. Further, the signal processing unit extracts a plurality of reference beacon tones from the captured plurality of signals by identifying frequency characteristics and modulation characteristics of the plurality of signals. Furthermore, the signal processing unit establishes at least one baseline reference signal for the captured plurality of signals using the extracted plurality of reference beacon tones.

Additionally, the signal processing unit identifies a plurality of signal perturbations caused by an airborne object intersecting a transmission path of the at least one satellite by continuously comparing the plurality of signals with the established at least one baseline reference signal. Further, the signal processing unit detects a presence of at least one target object by analyzing amplitude fluctuations and doppler shifts in the captured plurality of signals. The at least one target object corresponds to a type of the airborne object. Furthermore, the signal processing unit validates the presence of the at least one target object detected by performing a correlation analysis between the identified plurality of signal perturbations and predetermined forward scatter characteristics. Additionally, the signal processing unit generates a target object detection event upon validating the presence of the at least one target object. Further, the signal processing unit outputs the generated target object detection event onto a user device. The target object detection event indicates target object characteristics.

Another aspect of the present disclosure provides a method to detect airborne intrusion using signals from low Earth orbit (LEO) satellites. The method includes capturing a plurality of signals from at least one satellite within a predefined frequency band. The plurality of signals may comprise downlink signals. The at least one satellite comprises a Low Earth Orbit (LEO) satellite. Further, the method includes extracting a plurality of reference beacon tones from the captured plurality of signals by identifying frequency characteristics and modulation characteristics of the plurality of signals. Furthermore, the method includes establishing at least one baseline reference signal for the captured plurality of signals using the extracted plurality of reference beacon tones.

Additionally, the method includes identifying a plurality of signal perturbations caused by an airborne object intersecting a transmission path of the at least one satellite by continuously comparing the plurality of signals with the established at least one baseline reference signal. Further, the method includes detecting a presence of at least one target object by analyzing amplitude fluctuations and doppler shifts in the captured plurality of signals. The at least one target object corresponds to a type of the airborne object. Furthermore, the method includes validating the presence of the at least one target object detected by performing a correlation analysis between the identified plurality of signal perturbations and predetermined forward scatter characteristics. Additionally, the method includes generating a target object detection event upon validating the presence of the at least one target object. Further, the method includes outputting the generated target object detection event onto a user device, wherein the target object detection event indicates target object characteristics.

Yet another aspect of the present disclosure provides a non-transitory computer readable medium comprising a processor-executable instructions that are executable by a processor. The processor captures a plurality of signals from at least one satellite within a predefined frequency band. The plurality of signals includes downlink signals. The at least one satellite comprises a Low Earth Orbit (LEO) satellite. Further, the processor extracts a plurality of reference beacon tones from the captured plurality of signals by identifying frequency characteristics and modulation characteristics of the plurality of signals. Furthermore, the processor establishes at least one baseline reference signal for the captured plurality of signals using the extracted plurality of reference beacon tones. Additionally, the processor identifies a plurality of signal perturbations caused by an airborne object intersecting a transmission path of the at least one satellite by continuously comparing the plurality of signals with the established at least one baseline reference signal.

Further, the processor detects a presence of at least one target object by analyzing amplitude fluctuations and doppler shifts in the captured plurality of signals. The at least one target object corresponds to a type of the airborne object. Furthermore, the processor validates the presence of the at least one target object detected by performing a correlation analysis between the identified plurality of signal perturbations and predetermined forward scatter characteristics. Additionally, the processor generates a target object detection event upon validating the presence of the at least one target object. Further, the processor outputs the generated target object detection event onto a user device. The target object detection event indicates target object characteristics.

To further clarify the features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

Features of the disclosed embodiments are illustrated by way of example and not limited in the following Figure(s), in which like numerals indicate like elements, in which:

FIG. 1 illustrates an example block diagram representation of a system for detecting airborne intrusions using signals from low earth orbit (LEO) satellites, according to an example.

FIG. 2 illustrates an example block diagram representation of a receiver, such as shown in FIG. 1, capable of detecting airborne intrusions using signals from low earth orbit (LEO) satellites, according to an example.

FIG. 3 illustrates an example graphical representation of a starlink channel characteristics of the system, according to an example.

FIG. 4 illustrates an example graphical representation of a forward scatter geometry, depicting angle between an antenna and an airborne object along with velocity and height difference of a satellite and the antenna of the system, according to an example.

FIG. 5 illustrates an example experimental setup of the system for detecting an airborne object using the plurality of downlink signals from low earth orbit (LEO) satellites, according to an example.

FIG. 6 illustrate an example graphical representation of a unique doppler shifts due to geometrically visible satellites of the system, according to an example.

FIG. 7 illustrates an example graphical representation of MATLAB simulation of signal with doppler frequency drift due to movement of the at least one satellite, according to an example.

FIG. 8 illustrates an example graphical representation of extraction of peak information from signal for Doppler identification of the system, according to an example.

FIG. 9 illustrates an example graphical representation of MATLAB simulation of received signal after Doppler compensation of the system, according to an example.

FIG. 10 an example flow diagram representation of a method to detect airborne intrusions using signals from low Earth orbit (LEO) satellites, according to an example.

Further, those skilled in the art will appreciate those elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration”. Any embodiment or implementation of the present subject matter described herein as “exemplary” is not necessarily to be construed as preferred or advantageous over other embodiments. The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment”, “in an exemplary embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting. A computer system (standalone, client, server, or computer-implemented system) configured by an application may constitute a “module” (or “subsystem”) that is configured and operated to perform certain operations. In one example, the “module” or “subsystem” may be implemented mechanically or electronically, so a module includes dedicated circuitry or logic that is permanently configured (within a special-purpose processor) to perform certain operations. In another example, a “module” or a “subsystem” may also comprise programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

Examples of the present disclosure provides a system and method to detect airborne intrusions using signals from low Earth orbit (LEO) satellites. The system includes an antenna, a signal processing unit, and a user device. Further, the antenna captures a plurality of signals from at least one satellite within a predefined frequency band. The plurality of signals comprises downlink signals. The at least one satellite comprises a Low Earth Orbit (LEO) satellite. Further, the signal processing unit extracts a plurality of reference beacon tones from the captured plurality of signals by identifying frequency characteristics and modulation characteristics of the plurality of signals. Furthermore, the signal processing unit establishes at least one baseline reference signal for the captured plurality of signals using the extracted plurality of reference beacon tones.

Additionally, the signal processing unit identifies a plurality of signal perturbations caused by an airborne object intersecting a transmission path of the at least one satellite by continuously comparing the plurality of signals with the established at least one baseline reference signal. Further, the signal processing unit detects a presence of at least one target object by analyzing amplitude fluctuations and doppler shifts in the captured plurality of signals. The at least one target object corresponds to a type of the airborne object. Furthermore, the signal processing unit validates the presence of the at least one target object detected by performing a correlation analysis between the identified plurality of signal perturbations and predetermined forward scatter characteristics. Additionally, the signal processing unit generates a target object detection event upon validating the presence of the at least one target object. Further, the signal processing unit outputs the generated target object detection event onto the user device. The target object detection event indicates target object characteristics.

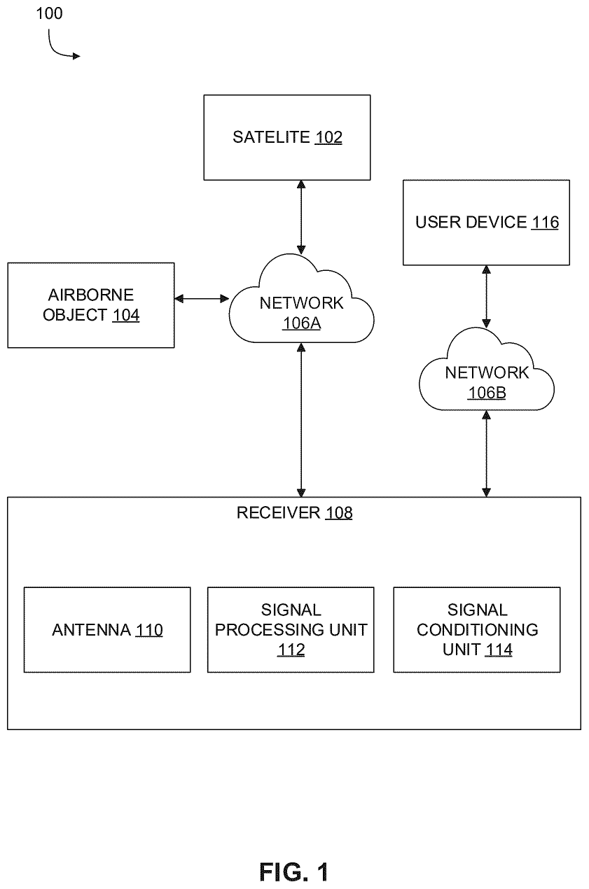

Referring now to the drawings, and more particularly to FIG. 1 through FIG. 10, where similar reference characters denote corresponding features consistently throughout the figures, there are shown preferred embodiments, and these embodiments are described in the context of the following example system and/or method.

FIG. 1 illustrates an example block diagram representation of a system 100 for detecting airborne intrusions using signals from low earth orbit (LEO) satellites, according to an example. In some examples, the system 100 may include at least one satellite 102. In some examples, the at least one satellite 102 may include, but not limited to, a transponder satellite, a regenerative satellite, and/or other similar satellite, and the like. Further, in some examples, the at least one satellite 102 may operate in LEO orbit configuration. In some examples, the at least one satellite 102 may be a third-generation partnership project (3GPP) standard-based terrestrial system, and non-terrestrial systems such as, but are not limited to, low earth orbiting (LEO) satellites, medium earth orbiting (MEO) satellites, geosynchronous earth orbiting (GEO) satellites, and/or other satellite types, and the like.

In an example, the system 100 may include the at least one satellite 102 communicatively coupled to a network 106A, a receiver 108, a user device 116 and a network 106B. Further, the at least one satellite 102 may be communicatively connected to the network 106A and the network 106A may be further connected to the receiver 108. Furthermore, the receiver 108 may include an antenna 110, a signal processing unit 112, and a signal conditioning unit 114. Furthermore, the user device 116 may be communicatively coupled to the network 106B and the network 106B may be further connected to the receiver 108.

In an example, the receiver 108 may be implemented as a standalone device such as a networking apparatus or device. In another example, each of the user device 116 and the receiver 108 may be implemented and integrated into an existing network device/network apparatus such as a mobile terminal, user equipment (UE), and/or web/cloud server.

In an example, the user device 116 may include, but not limited to, a smartphone, a mobile phone, a personal digital assistant, a tablet computer, a tablet computer, a wearable device, a computer, a laptop computer, an augmented/virtual reality device (A/VR), internet of things (IoT) device, a camera, any other device, and the combination thereof. In an example, the user device 116 may include a processor (not shown in FIG. 1) and a memory (not shown in FIG. 1) operatively coupled with the processor. The memory includes processor-executable instructions in the form of a plurality of modules. The processor executes the plurality of modules to perform a plurality of steps described below.

Further, the user device 116 may be used by for example, but not limited to, a user, a customer, an administrator, a network operator, a media content operator, an over-the-top (OTT) operator, any other operator, and/or type of users. Furthermore, although the user device 116 may typically remain in the same location once mounted, the user device 116 may be removed from their mounts, relocated to another location, and/or may be configured to be mobile terminals. For example, the user device 116 may be mounted on mobile platforms that facilitate transportation thereof from one location to another. Such mobile platforms may include, for example, any number of mobile vehicles, such as airplanes, cars, buses, boats, trucks, troop carriers, or other vehicles, and/or other types of vehicles/commuting means. It should be appreciated that such user device 116 may generally be operational when still and not while being transported. That said, there may be scenarios where the user device 116 may be transportable (mobile) terminals that remain operational during transit. As used herein, the terms “user device”, “terminal,” “customer terminal,” “satellite terminal,” “very small aperture terminal (VSAT)”, and/or “user terminal”, may be used interchangeably to refer to these terminal types.

The user device 116 may be configured to collect information from data stored in the network 106B. Further, the user device 116 may examine the data stored in the network 106B. Furthermore, the examination of the data stored in the network 106B may be done via at least one of recognition of raw data, elimination of noise from the raw data, and identification at least one target object. Furthermore, the user device 116 may track a plurality of movements of the at least one target object. Furthermore, the user device 116 may predict trajectory of the at least one object. Furthermore, the user device 116 may activate one or more countermeasures. Furthermore, the one or more countermeasures may, for example, include but not limited to blocking and neutralization of a specified area where a trajectory of the at least one object may be predicted. Furthermore, the user device 116 may evaluate a threat level of the at least one object. Furthermore, the threat level may be identified based on a sensitivity of an area. The sensitivity of the area may be identified based on a behavior of the at least one object and a proximity of the at least one object. Furthermore, the user device 116 may record data in the network 106B for improving the system 100.

In an example, the signal processing unit 112 may identify a plurality of signal perturbations caused by the airborne object 104 intersecting a transmission path of the at least one satellite 102 by continuously comparing the plurality of signals with the established at least one baseline reference signal. Further, the airborne object 104 may be any obstacle, such as, for example, a building, an object, a drone or a tree or a bird or an aircraft or any other article that blocks signals emanating from the at least one satellite 102. Furthermore, the plurality of signal perturbations may be indicative of the airborne object 104. The plurality of signal perturbations may include amplitude fluctuations due to forward scatter gain effects, additional doppler shifts caused by the motion of the airborne object 104 relative to the at least one satellite 102 and a receiver link.

In some examples, the at least one satellite 102 may be an artificial satellite that may be configured to transmit and receive data signals. For example, the at least one satellite 102 may form one or more beams (for example, spot beams) and provide connectivity to the user device 116. It should be appreciated that the at least one satellite 102 may form any number of beams to communicate data signals with any number of components.

The at least one satellite 102 may include a Radio Frequency (RF) signal monitor. Further, the RF signal monitor may be configured to communicate with the airborne object 104. Furthermore, the at least one satellite 102 may monitor radio frequencies (RF) signal. Furthermore, the at least one satellite 102 may intercept RF signal. Furthermore, the at least one satellite 102 may analyze RF signals to detect presence of the airborne object 104. The at least one satellite 102 may monitor large areas in at least one of a real-time and a near-real-time to obtain information. Furthermore, the at least one satellite 102 may transmit the obtained information back to a plurality of ground control systems via a plurality of communication links. Furthermore, the obtained information may, for example, include but not limited to location, altitude, speed, and trajectory of the airborne object 104. Furthermore, the plurality of communication links may, for example, include but not limited to a high-frequency radio link and a downlink data transfer.

The airborne object 104 may be for example, but not limited to, Unmanned Aircraft Systems (UAS), Unmanned Aircraft (UA), UAV, RPV (Remote-Piloted Vehicle), Unmanned Air Combat Vehicle (UCAV), Remotely Operated Aircraft (ROA), drones, rockets, missiles, and the like. Though used interchangeably, RPV refers to anything controlled externally by remote control, while UAV generally describes an aircraft piloted from the ground or controlled autonomously with an in-flight computer and/or a pre-programmed flight plan. The term ROA was developed by the Federal Aviation Administration (FAA) for correspondence to certain legal requirements. The terms UAS and UA are recently respectively used to refer to the unmanned system and the flying component of the system. The present disclosure also incorporate other vehicles, which may be either piloted or operating in an unmanned mode, such as private and commercial planes, water vessels such as boats and ships, and road and rail vehicles, space-going vehicles, to name a few. For convenience, the airborne object 104 as used herein shall broadly encompass all such related terms and concepts and shall not be limited to an unmanned vehicle.

The network 106A may be communicatively coupled to the at least one satellite 102 and the receiver 108. Further, the network 106A may ensure at least one of an effective communication, a data integrity, and a real-time decision-making. Furthermore, the network 106A may be configured to perform a plurality of functions. Furthermore, the plurality of functions may include but not limited to data transmission, sensor fusion, automated responses, and coordinated actions. Furthermore, the network 106A may detect the airborne object 104. Furthermore, the network 106A may track the airborne object 104. Furthermore, the network 106A may respond to a plurality of messages received from the airborne object 104. Furthermore, the network 106A may ensure an airspace security across a plurality of areas. Furthermore, the plurality of area may include but not limited to remote and hard-to-reach areas.

The network 106B may be wired, or wireless networks. Wired networks include any of a wide variety of well-known means for coupling voice and data communications devices together. A brief discussion of various exemplary wireless network technologies that may be used to implement the examples of the present invention now are discussed. The examples are non-limited. Exemplary wireless network types may include, for example, but not limited to, code division multiple access (CDMA), spread spectrum wireless, orthogonal frequency division multiplexing (OFDM), 1G, 2G, 3G wireless, 4G, 5G or 6G, Bluetooth, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB), and the like.

IrDA is a standard method for devices to communicate using infrared light pulses, as promulgated by the Infrared Data Association from which the standard gets its name. As IrDA devices use infrared light, such device may depend on being in line of sight with each other.

The examples of the present invention may make reference to WLANs. Examples of a WLAN may include a shared wireless access protocol (SWAP) developed by Home Radio Frequency (HomeRF), and wireless fidelity (Wi-Fi), a derivative of IEEE 802.11, advocated by the wireless Ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, for example, but not limited to, wireless LANs compliant with IEEE std. 802.11a, b, d or g, such as, for example, but not limited to, IEEE std. 802.11 a, b, d and g, (including, for example, but not limited to IEEE 802.11g-2003, and the like), and the like.

In some examples, the system 100 may also include a private network and/or public network (not shown in FIG. 1). The private network and/or public network may include any variations of networks. For example, the private network may be a local area network (LAN), and the public network may be a wide area network (WAN). Also, the private network and/or public network may each be a local area network (LAN), wide area network (WAN), the Internet, a cellular network, a cable network, a satellite network, or other networks that facilitate communication between the components of network architecture 100A as well as any external element or system connected to the private network and/or public network. The private network and/or public network may further include one, or any number, of the example types of networks mentioned above operating as a stand-alone network or in cooperation with each other. For example, the private network and/or public network may utilize one or more protocols of one or more clients or servers to which they are communicatively coupled. The private network and/or public network may facilitate the transmission of data according to a transmission protocol of any of the devices and/or systems in the private network and/or public network. Although each of the private network and/or public networks may be a single network, it should be appreciated that in some examples, each of the private network and/or public networks may include a plurality of interconnected networks as well.

Further, the network architecture may be defined as design and structure of a computer network, which may include components, layout, communication protocols, and data flow mechanisms of the computer network. Furthermore, the network architecture may define, the way in which a plurality of devices may be connected to one another. Furthermore, the network architecture may also define the way in which data may travel between the plurality of devices. Furthermore, the plurality of devices may, for example, include but not limited to computers, servers, routers, and switches. Furthermore, the network architecture may, for example include, but not limited to a physical layer, logical layer, a plurality of topologies, a plurality of protocols. Furthermore, the physical layer may, for example include, but not limited to connections and devices. Furthermore, connections and devices may include but not limited to cables, routers, switches, and hardware used in the network. Furthermore, the logical layer may provide a technique in which the computer network may be structured logically. Furthermore, the technique may include but not limited to IP addressing, routing, and the protocols, which may manage communication between the plurality of devices. Furthermore, the plurality of devices may include but not limited to an Ethernet, a Transmission Control Protocol (TCP), and an Internet Protocol (IP). Furthermore, the plurality of topologies may provide an arrangement of connection of the plurality of device. Furthermore, the plurality of devices may be connected in a plurality of topologies. Furthermore, the plurality of topologies may include but not limited to a star topology, a mesh topology, a bus topology, and a ring topology. Furthermore, the plurality of protocol may include a set of rules and standards. Furthermore, the set of rules and standards may govern but not limited to a data transmission and a network communication. Furthermore, the data transmission and the network communication may include but not limited to a Hypertext Transfer Protocol (HTTP), a Domain Name System (DNS), a Transmission Control Protocol/Internet Protocol (TCP/IP).

While the processors, components, elements, systems, subsystems, and/or other computing devices may be shown as single components or elements, one of ordinary skill in the art would recognize that these single components or elements may represent multiple components or elements and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system, and components, as shown in FIG. 1.

In an example, the user device 116 may include one or more applications (not shown in FIG. 1). Further, the one or more applications may include, but not limited to, hypertext transfer protocol (HTTP) components, web application frameworks, content management systems (CMS), server-side scripting languages, authentication and authorization modules, web services, application programming interfaces (APIs), caching and load balancing mechanisms, e-commerce applications, social media platforms, over-the-top (OTT) applications, any other applications, and a combination thereof.

In an example, the system 100 may include the antenna 110, the signal processing unit 112, and the user device 116. Furthermore, the antenna 110 may capture a plurality of signals from the at least one satellite 102 within a predefined frequency band. Furthermore, the plurality of signals may comprise downlink signals. Furthermore, the at least one satellite 102 may include a Low Earth Orbit (LEO) satellite. Furthermore, the signal processing unit 112 may extract a plurality of reference beacon tones from the captured plurality of signals by identifying frequency characteristics and modulation characteristics of the plurality of downlink signals. In an example, the frequency characteristics may include doppler shift (referring to the frequency shift in received signals due to the relative motion of an airborne object (for example, a drone) crossing the transmission path between the satellite and the receiver), a micro-doppler effects (referring to high-frequency fluctuations superimposed on the primary doppler shift, caused by rotating components of the object (for example, drone propellers)), a beacon tone stability (referring to the inherent frequency stability of the narrowband beacon signals used for tracking and detection), and a spectral content (referring to the overall distribution of signal energy across frequencies, which may exhibit distortions due to forward scatter effects).

In an example, the modulation characteristics may include Amplitude Modulation (AM) (referring to variations in signal amplitude caused by the forward scatter effect, which results in periodic signal strength fluctuations when an object crosses the transmission path), a Frequency Modulation (FM) (referring to doppler-induced frequency shifts that provide velocity information about the detected object), a Phase Modulation (PM) (referring to changes in the signal phase due to multipath propagation and object motion, which may be analyzed to determine additional movement characteristics) and temporal modulation patterns (referring to the time-dependent variations in amplitude and frequency, which may be used to distinguish between different types of airborne objects).

Furthermore, the signal processing unit 112 may establish at least one baseline reference signal for the captured plurality of signals using the extracted plurality of reference beacon tones. Additionally, the signal processing unit 112 may identify a plurality of signal perturbations caused by the airborne object 104 intersecting a transmission path of the at least one satellite 102 by continuously comparing the plurality of signals with the established at least one baseline reference signal. Further, the signal processing unit 112 may detect a presence of at least one target object by analyzing amplitude fluctuations and doppler shifts in the captured plurality of signals. Further, at least one target object may correspond to a type of the airborne object 104. In an example, the at least one target object may be a drone. Furthermore, the signal processing unit 112 may validate the presence of the at least one target object detected by performing a correlation analysis between the identified plurality of signal perturbations and predetermined forward scatter characteristics. In an example, the predetermined forward scatter characteristics refer to known signal perturbations caused by an airborne object 104 intersecting the transmission path between a LEO satellite 102 and a ground receiver 108. These include enhanced radar cross-section (RCS), making small objects appear larger, V-shaped Doppler signatures, indicating velocity and trajectory, micro-Doppler fluctuations, distinguishing drones from other objects, and amplitude variations, caused by destructive interference at the baseline. These characteristics enable accurate detection and classification of airborne objects, such as drones, using passive radar systems without active transmissions.

Furthermore, the signal processing unit 112 may generate a target object detection event upon validating the presence of the at least one target object. Furthermore, the signal processing unit 112 may output the generated target object detection event onto the user device 116. Furthermore, the target object detection event may indicate target object characteristics. In an example, the target object characteristics refer to identifiable attributes of an airborne object detected through signal analysis in a passive radar system. These characteristics may include radar cross-section (RCS), which indicates the object's apparent size based on forward scatter effects, Doppler shift patterns, which reveal velocity and movement relative to the transmission path, micro-Doppler signatures, which may distinguish drones from birds or other flying objects based on rotor blade rotation, and amplitude fluctuations, which provide additional confirmation of object presence. By analyzing these characteristics, the receiver 108 may classify the detected object and differentiate between various airborne targets.

It should be appreciated that the system 100 depicted in FIG. 1 may be a few example implementations. Hence, the system 100 may or may not include additional features and some of the features described herein may be removed and/or modified without departing from the scope of the system 100 outlined herein.

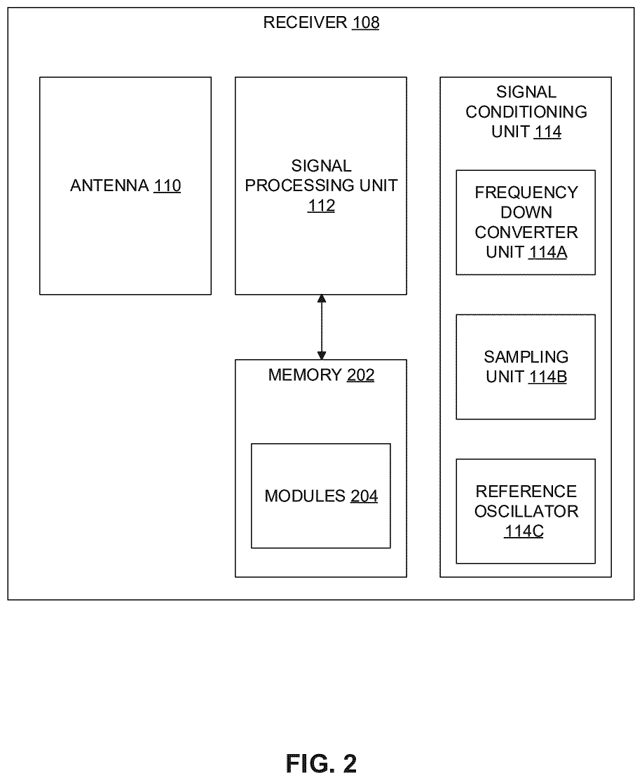

FIG. 2 illustrates an example block diagram 200 representation of the receiver 108, such as shown in FIG. 1, capable of detecting airborne intrusions using signals from low earth orbit (LEO) satellites, according to an example.

In an example, the receiver 108 may include the signal processing unit 112 (interchangeably referred herein as the processor 112) and a memory 202 operatively coupled with the processor 112. Further, the memory 202 may include processor-executable instructions in the form of the plurality of modules 204. Furthermore, the processor 112 may execute the plurality of modules 204 to perform a plurality of steps described below. Furthermore, the plurality of modules 204 associated with the system 100 may detect airborne intrusions using signals from low Earth orbit (LEO) satellites. Execution of the machine-readable program instructions by the signal processing unit 112 may enable the receiver 108 to perform one or more functions. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The signal processing unit 112 may include, for example, microprocessors, microcomputers, microcontrollers, digital signal processors, central processing units, state machines, logic circuits, and/or any devices that manipulate data or signals based on operational instructions. Among other capabilities, the signal processing unit 112 may fetch and execute computer-readable instructions from the memory 202 operationally coupled with the receiver 108 for performing tasks such as data processing, input/output processing, attributes extraction, and/or any other functions. Any reference to a task in the present disclosure may refer to an operation being, or that may be, performed on data or input information.

In an example, the receiver 108 of the system 100 may include the antenna 110, the signal processing unit 112, and the signal conditioning unit 114. Further, the antenna 110 may capture a plurality of signals from the at least one satellite 102 within a predefined frequency band. For example, in a Low Earth Orbit (LEO) satellite communication system, the predefined frequency band may fall within a Ku-band (12-18 GHz) commonly used for satellite downlinks, such as 11.2-12.7 GHz for commercial satellite communications. Further, the predefined frequency band may fall within a Ka-band (26.5-40 GHz) used for high-throughput satellite transmissions, including 27.5-30 GHz for uplinks and 17.7-21.2 GHz for downlinks. Furthermore, the predefined frequency band may fall within a L-band (1-2 GHz) used for navigation, GPS, and some low-bandwidth satellite communications, such as 1.5-1.6 GHz for mobile satellite services. In this disclosure, the predefined frequency band may correspond to beacon tones or telemetry signals transmitted by satellites (for example, 11.325 GHz for Starlink beacon tones), ensuring accurate detection and processing of satellite-based passive radar signals.

Furthermore, the plurality of signals may comprise downlink signals. Furthermore, the at least one satellite 102 may include a Low Earth Orbit (LEO) satellite. Furthermore, the signal processing unit 112 may extract a plurality of reference beacon tones from the captured plurality of signals by identifying frequency characteristics and modulation characteristics of the plurality of signals. Furthermore, the signal processing unit 112 may establish at least one baseline reference signal for the captured plurality of signals using the extracted plurality of reference beacon tones. Additionally, the signal processing unit 112 may identify a plurality of signal perturbations caused by the airborne object 104 intersecting a transmission path of the at least one satellite 102 by continuously comparing the plurality of signals with the established at least one baseline reference signal. Furthermore, the plurality of signal perturbations may include an interference. Furthermore, the interference may be caused by a plurality of radio frequency (RF) signals affecting a wireless communication system. Furthermore, the airborne object 104 may cause the plurality of signal perturbations. Furthermore, the plurality of signal perturbations may for example include but not limited to an Electromagnetic Interference (EMI), a multipath fading, a Doppler shift, and a bandwidth saturation. Furthermore, the EMI may be caused by electronic components of the airborne object 104. Furthermore, the EMI may interfere with other wireless systems operating in the same frequency range, which may cause a disruption of communication. Furthermore, the multipath fading may cause intermittent signal loss in data transmission. Furthermore, the doppler shift may cause issues with signal synchronization, data loss, and difficulties in maintaining a stable communication link. Furthermore, the bandwidth saturation may impact quality of connection and service due to at least one of a congestion and a signal interference.

Furthermore, the signal processing unit 112 may detect a presence of at least one target object by analyzing amplitude fluctuations and doppler shifts in the captured plurality of signals. Furthermore, at least one target object may correspond to a type of the airborne object 104. In an example, the at least one target object may be a drone. Furthermore, the signal processing unit 112 may validate the presence of the at least one target object detected by performing a correlation analysis between the identified plurality of signal perturbations and predetermined forward scatter characteristics. The plurality of signal perturbations such as, for example, but not limited to, amplitude dips, doppler shifts, and phase changes. The correlation analysis may involve template matching of the amplitude envelope, doppler spectrogram alignment, or machine learning-based classification of extracted signal features. A high correlation score may indicate a likely match, triggering a target object detection event. Furthermore, the signal processing unit 112 may generate a target object detection event upon validating the presence of the at least one target object. Furthermore, the signal processing unit 112 may output the generated target object detection event onto the user device 116. Furthermore, the target object detection event may indicate target object characteristics.

In an example, the receiver 108 may include the signal conditioning unit 114. The signal conditioning unit 114 may be communicatively coupled to the antenna 110. Further, the signal conditioning unit 114 may include a frequency down converter unit 114A, a sampling unit 114B and a reference oscillator 114C. Further, the frequency down converter unit 114A may down convert a frequency of the captured plurality of signals to intermediate frequency signals. Furthermore, the sampling unit 114B may sample the intermediate frequency signals at a predetermined rate to generate sampled signals. Furthermore, the reference oscillator 114C may synchronize clocks of the frequency down converter unit 114A and the sampling unit 114B with an external GPS (Global Positioning System) oscillator. Further, the external GPS oscillator may use a plurality of GPS signals to provide at least one of a highly accurate timing and a frequency reference for various applications. Furthermore, the external GPS oscillator may ensure precision and stability for a plurality of time-critical applications. Furthermore, the plurality of time-critical applications may include but not limited to telecommunications, scientific research, military systems, and more. Further, the external GPS oscillator may be used to discipline local oscillators, synchronize network equipment, and offer a reliable time reference for distributed systems across the globe.

In an example, the signal processing unit 112 may extract the plurality of reference beacon tones from the captured plurality of signals by identifying frequency characteristics and modulation characteristics of the plurality of signals. Further, the signal processing unit 112 may extract the plurality of reference beacon tones separated by a specific spacing within a reference signal bandwidth of the captured plurality of signals. Furthermore, the signal processing unit 112 may further compensate doppler shifts caused by a satellite motion using Short Time Fourier Transform (STFT) analysis by applying a frequency correction model. This frequency correction model may include linear Doppler estimation based on satellite velocity, Kalman filter-based frequency tracking, non-linear polynomial interpolation over STFT peaks, or lookup table-based correction using precomputed orbital Doppler profiles.

In an example, the signal processing unit 112 may identify the plurality of signal perturbations caused by the airborne object 104 intersecting the transmission path of the at least one satellite 102. Further, the signal processing unit 112 may detect a plurality of fluctuations in the plurality of reference beacon tones indicative of forward scatter effects caused by the airborne object 104 crossing a line-of-sight path between the at least one satellite 102 and the antenna 110. Furthermore, the plurality of fluctuations may include amplitude fluctuations. Furthermore, the signal processing unit 112 may compute doppler shifts in the plurality of reference beacon tones based on the detected plurality of fluctuations. Furthermore, the doppler shifts may be computed by computing frequency shifts over time using, for example, but not limited to, Fast Fourier Transform (FFT) and Short Time Fourier Transform (STFT) methods. Furthermore, the Doppler shifts may be computed by analyzing frequency variations over time using, for example, but not limited to, spectral methods such as the Fast Fourier Transform (FFT), which provides a high-resolution snapshot of frequency content, and the Short Time Fourier Transform (STFT), which enables time-resolved tracking of dynamic Doppler shifts. These tools allow the signal processing unit to identify how the frequency of beacon tones deviates from the nominal reference as a result of the object's motion across the transmission path. Furthermore, the signal processing unit 112 may identify the plurality of signal perturbations caused by the airborne object 104 intersecting the transmission path of the at least one satellite 102 based on the computed doppler shifts.

In an example, the signal processing unit 112 may detect the presence of the at least one target object by analyzing the amplitude fluctuations and the doppler shifts in the captured plurality of signals. Further, the signal processing unit 112 may identify an additional doppler shift component forming a V-shaped signature in a spectrogram. Furthermore, the additional doppler shift component may indicate a presence of the at least one target object. Furthermore, the signal processing unit 112 may estimate a velocity value and a trajectory data of the at least one target object relative to the established at least one baseline reference signal based on the identified additional doppler shift component.

In an example, the signal processing unit 112 may validate the presence of the at least one target object detected by performing the correlation analysis between the identified plurality of signal perturbations and predetermined forward scatter characteristics. Further, the signal processing unit 112 may isolate a specific-frequency micro-doppler fluctuations superimposed on a primary Doppler shift signal. Furthermore, the signal processing unit 112 may identify a plurality of frequency modulations caused by rotating object propellers to distinguish the at least one target object from other airborne objects. In an example, the other airborne objects may be, for example, birds, or other obstacles. In an example, the rotating object propellers may refer to a plurality of rotating blades of a propeller. Further, the rotating object propellers may be used to generate at least one of a thrust and a lift in a plurality of machines. Furthermore, the plurality of machines may include but not limited to aircraft, drones, and helicopters. Furthermore, the rotating object propellers may generate a force, which may propel an object to move in any of the desired direction. Furthermore, the signal processing unit 112 may determine a type of the airborne object 104 by correlating the isolated specific-frequency micro-doppler fluctuations with a pre-trained classification model. This pre-trained classification model may include machine learning architectures such as, for example, but not limited to, support vector machines (SVMs), convolutional neural networks (CNNs) trained on spectrogram images, or recurrent models such as long short-term memory (LSTMs) that process time-series Doppler features. These models are trained on labeled datasets containing micro-Doppler signatures of various airborne objects. Furthermore, the signal processing unit 112 may validate the presence of the at least one target object detected based on the determined type of the airborne object 104. This validation step confirms that the identified perturbations are caused by a relevant object, such as a drone, by correlating the classified object type with a list of target types. This approach ensures that only meaningful intrusions characterized by matching both signal disruption patterns and object identity are treated as valid detection events.

Additionally, the signal processing unit 112 may output the generated target object detection event onto the user device 116. Furthermore, the signal processing unit 112 may generate real-time alerts indicating the generated target object detection event. In an example, the alerts may include an intrusion alert, a proximity alert, an altitude alert, a collision risk alert, a jamming alert, and an GPS (Global Positioning System) spoofing alert. Further, the intrusion alert may be triggered when the airborne object 104 may enter restricted zone including but not limited to airports and military bases. Furthermore, the proximity alert may alert the user when the airborne object 104 may come close to a sensitive area. Furthermore, the altitude alert may notify when the airborne object 104 may go beyond a certain altitude threshold. Furthermore, the collision risk alert may warn when the airborne object 104 may be on a potential collision course with for example but not limited to another aircraft and object. Furthermore, the jamming alert may be triggered when a control signal may be suspected to be jammed. Furthermore, the GPS spoofing alert may notify when data of the airborne object 104 may appear to be false. The signal processing unit 112 may display the generated real-time alerts on a graphical interface of the user device 116.

In an example, the signal processing unit 112 may identify a subset of satellites transmitting the plurality of reference beacon tones from among a set of geometrically visible satellites above a predefined elevation angle. Further, the signal processing unit 112 may determine beam coverage patterns associated with the identified subset of satellites. Furthermore, the signal processing unit 112 may select appropriate at least one satellite 102 from among the identified subset of satellites based on the determined beam coverage patterns. Furthermore, the appropriate at least one satellite 102 may actively transmit the plurality of reference beacon tones towards a detection area.

In an example, the signal processing unit 112 may compute a forward scatter gain using a set of parameters, including the wavelength of the downlink frequency, the cross-sectional area, and linear dimensions of the target object. The forward scatter gain G can be computed using the relation:

$$G = ( 4 π A ) / ( {λ}^{2} ) \qquad equation ( 1 )$$

where, in the above equation 1, the variable ‘A’ may refer to an effective cross-sectional area of the airborne object and ‘λ’ is the wavelength of the satellite downlink signal. This computed gain characterizes the strength of the forward scattered signal received by the antenna, and enables reliable detection of target objects based on perturbations caused by target crossings. Further, the set of parameters may include a wavelength of a downlink frequency, a cross-sectional area of the at least one target object, and a linear dimension of the at least one target object. Furthermore, the signal processing unit 112 may compute an apparent Radar Cross-Section (RCS) value of the at least one target object based on the computed forward scatter gain. Specifically, the RCS is estimated using the relation, where A is the effective cross-sectional area of the airborne object and A is the wavelength of the satellite downlink signal. This RCS value provides a quantitative measure of how much power is forward-scattered toward the receiver, and aids in identifying and characterizing airborne intrusions. Furthermore, the resulting RCS provides a measure of the object's effective electromagnetic size as observed through passive forward scatter, enabling enhanced classification and detection. Furthermore, the receiver 108 may detect airborne intrusions using a plurality of downlink signals from low Earth orbit (LEO) satellites.

In an example, interconnect terminal (not shown in FIG. 2) may interconnect various subsystems, elements, and/or components of the receiver 108. Further, the interconnect may be an abstraction that may represent any one or more separate physical buses, point-to-point connections, or both, connected by appropriate bridges, adapters, or controllers. In some examples, the interconnect may include a system bus, a peripheral component interconnect (PCI) bus, or PCI-express (PCIe) bus, a hyper transport (HT) or industry standard architecture (ISA)) bus, a small computer system interface (SCSI) bus, a universal serial bus (USB), inter-integrated circuit (IIC or I2C) bus, or an institute of electrical and electronics engineers (IEEE) standard 1394 bus, or “firewire,” or other similar interconnection element.

In some examples, the interconnect may allow data communication between the signal processing unit 112 and the memory 202, which may include read-only memory (ROM) or flash memory (neither shown), and random-access memory (RAM). It should be appreciated that the RAM may be the main memory into which an operating system and various application programs may be loaded. Further, ROM or flash memory may contain, among other code, the basic input-output system (BIOS) which controls basic hardware operation such as the interaction with one or more peripheral components.

In an example, the signal processing unit 112 may be the central processing unit (CPU) of the computing device and may control an overall operation of the computing device. In some examples, the signal processing unit 112 may accomplish this by executing software or firmware stored in system memory or other data via the storage. Further, the signal processing unit 112 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

In an example, the computing device may refer to any apparatus, which may manipulate data using hardware and software. Further, the computing device may include, but not limited to a processor, a memory, a storage and an input and output interface. Furthermore, the computing device may execute a plurality of functions including but not limited to calculations, communication, and control. Furthermore, the computing device may be available in numerous formats, ranging from personal computers and smartphones to specialized systems. Furthermore, the specialized systems may for example include but not limited to servers and supercomputers.

In an example, multimedia adapter (not shown in FIG. 2) may connect to various multimedia elements or peripherals. Furthermore, various multimedia elements or peripherals may include a device associated with visual (for example, video card or display), audio (for example, sound card or speakers), and/or various input/output interfaces (for example, mouse, keyboard, touchscreen).

Many other devices, components, elements, or subsystems (not shown) may be connected in a similar manner to the interconnect or via a network. Code or computer-readable instructions to implement the present disclosure may be stored in computer-readable storage media such as one or more of system memory or other storage. Code or computer-readable instructions to implement the present disclosure may also be received via one or more interfaces and stored in the memory 202.

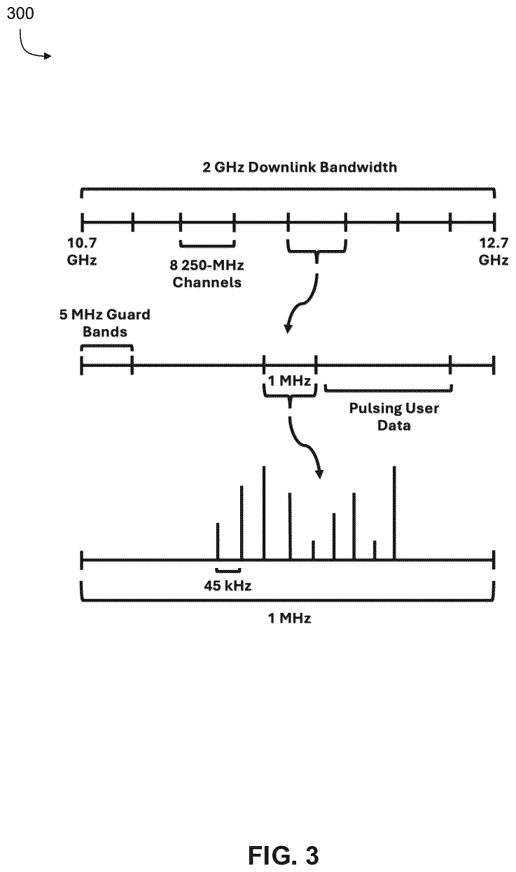

FIG. 3 illustrates an example graphical representation of a starlink channel characteristics 300 of the system 100, according to an example. The system 100 may be similar to the receiver 108 as shown in FIG. 1 and FIG. 2. According to FIG. 3, the system 100 may be capable of detecting airborne intrusions using a plurality of downlink signals from low earth orbit (LEO) satellites. Further, the present disclosure proposes a novel method of drone detection using forward scatter passive radar with downlink signals from LEO satellites. Furthermore, system 100 may emphasize on a Starlink LEO constellation because of sheer size of the Starlink LEO constellation. Furthermore, the Starlink LEO constellation may include over 6,000 operating satellites in orbit. Furthermore, multiple satellites may be visible with high signal strength from anywhere on Earth at any moment. Furthermore, the abundance of downlinks may lend to a very useful drone detection scheme, which may work in any location. Furthermore, the Starlink LEO constellation may operate on many different radio frequency (RF) bands for uplink and downlink on a user, a gateway, and a telemetry, tracking and command links (TT and C links) over at least two generations of satellites. Furthermore, best link to use for passive radar purposes may be a user downlink due to the capability of the user downlink to broadcast anywhere in the world where a Starlink user terminal may be located. In an example, a 10.7-12.7 GHz band may be particularly useful because the 10.7-12.7 GHz band may be used in both generations of a plurality of Starlink satellites, thereby 10.7-12.7 GHz band may be the most likely to have constant illumination. Further, a 2 GHz bandwidth of Ku-band downlink band may be split into 8 250-MHz channels. Furthermore, a 1-MHz section may be in the middle of each channel for a reference signal, however, rest of the channel may transmit pulsing a user data on demand. Furthermore, a 1 MHz reference signal may be the most useful for passive radar because the 1 MHz reference signal of the channel may be constantly transmitting an unchanging signal, simultaneously, the user data may pulse inconsistently. Furthermore, the plurality of Starlink satellites may also adjust a transmission power to keep a constant power flux density at ground level. Furthermore, the adjustment may compensate for different orbital altitudes and inclinations. Therefore, the transmission power of the 1 MHz reference signal may remain constant across the plurality of Starlink satellites as well.

In an example, the system 100 for detecting airborne intrusions using a plurality of downlink signals from low earth orbit (LEO) satellites may also use the plurality of Starlink satellite signals as a plurality of illuminators. Further, the system 100 may include designing the receiver 108 shown in FIG. 1 and FIG. 2. Furthermore, the receiver 108 may capture the plurality of signals. Furthermore, the receiver 108 may differentiate between a plurality of raw signals, which may be directly coming from the plurality of Starlink satellites and a perturbed signal. Furthermore, the perturbed signal may be due to flying an intruder object between the receiver 108 and the plurality of Starlink satellites.

Additionally, within the 1 MHz reference signal, a bandwidth may be of 9 continuous beacon tones, the amplitudes may have different combinations for different satellites, which may be a way for a Starlink user terminal to identify the satellite, the Starlink user terminal may be communicating with. The 1 MHz reference signal may be the signals of interest. Further, the Starlink user terminal may be a black box, in which data may be accessed over the public Application programming interface (API) in a mobile app, which may be essentially limited to one of an uplink data rate or a downlink data rate and latency.

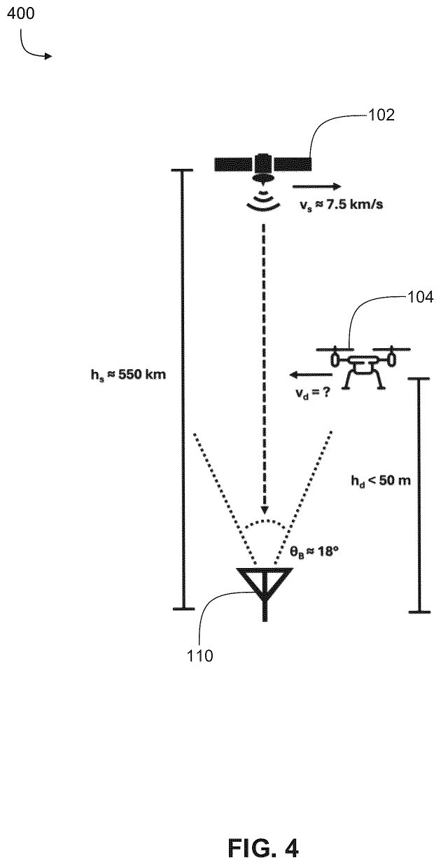

FIG. 4 illustrates an example graphical representation of a forward scatter geometry 400, depicting an angle between the antenna 110 and the airborne object 104 along with a velocity and a height difference of the at least one satellite 102 and the antenna 110 of the system 100, according to an example. In this case, the airborne object 104 may include but not limited to a drone. According to FIG. 4, the forward scatter geometry 400 may be shown, when the airborne object 104 may approach a baseline, a Doppler shift may be seen in the downlink due to the velocity of the drone relative to the baseline. When the airborne object 104 may get close to the baseline (as defined by Equation 3), the Doppler shift may shift to zero and the forward scatter property may be observed. Further, this may mean that although the airborne object 104 may fly near the baseline, the airborne object 104 may not necessarily need to fly exactly through the baseline to be detected. Further, an analysis of the forward scatter geometry 400 of test scenario of the system 100 may be performed. The system 100 may include, for example, but not limited to, a downlink frequency of 11 GHz and a consumer DJI Mavic 2 drone. The system 100 may get a plurality of values as defined in foregoing equation 1, where A may be the wavelength of the downlink frequency, A may be the cross-sectional area of the drone, and l may be the linear dimension of the drone.

$$λ = 0.0 \; 27 m , A = 0.078 {m}^{2} , l = 0.085 m \qquad ( 2 )$$

Additionally, using beforementioned information, the system 100 may calculate the apparent radar cross section (RCS) of the airborne object 104 in equation 2 to be 104.9 m², which may be equivalent of the actual RCS of a very large aircraft. Further, the system 100 may also calculate the angular width of the forward scatter geometry 400 in equation 3. Furthermore, the range of angles over which the forward scatter geometry 400 may be observed may be calculated to be 18.2°. Furthermore, the range of angles may be seen that as frequency increases, the observable range of the forward scattering property increases while the RCS decreases. Furthermore, over 100 m² may still be a sufficient RCS, the high frequency used by the LEO downlink.

$${σ}_{F S} = \frac{4 π {A}^{2}}{{λ}^{2}} = 104.9 {m}^{2} \qquad ( 3 )$$

$${θ}_{B} = \frac{λ}{l} = 18.2 ° \qquad ( 4 )$$

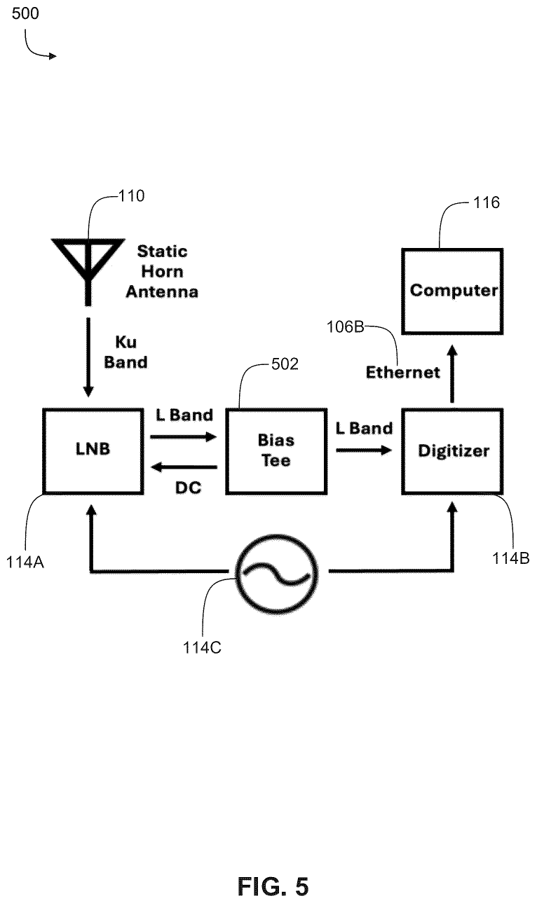

FIG. 5 illustrates an example experimental setup 500 of the system 100 for detecting the airborne object 104 using the plurality of downlink signals from low earth orbit (LEO) satellites, according to an example. According to FIG. 5, the example experimental setup 500 of the system 100 may include but not limited the antenna 110 (interchangeably used as a horn antenna), the frequency down converter 114A (interchangeably used as an LNB), the sampling unit 114B (interchangeably used as a digitizer), the reference oscillator 114C (interchangeably used as an external GPS disciplined oscillator), the user device 116 (interchangeably used as a computer) and a bias tee 502. Furthermore, the experimental setup 500 may include the horn antenna 110 with 10 dBi gain and a 50-degree beamwidth connected to an LNB 114A. The LNB 114A may convert a Ku-band signal down to an L-band. Furthermore, an L-band signal may be fed into the digitizer 114B for at least one of a digitization and a signal processing. Furthermore, the digitizer 114B may include but not limited to an X310 USRP clock. Furthermore, the LNB 114A and the X310 USRP clock may be synchronized using the external GPS disciplined oscillator 114C, which may be extremely accurate. Furthermore, 1 MHz of in the center of each 250-MHz user data channel may be allotted to the continuous beacon tones, which may define bandwidth of interest of the system 100. Furthermore, the adaptive power transmission scheme of the plurality of Starlink satellites may ensure that the downlink signal at ground level may be kept at a constant power flux density at ground level of roughly −98 dBW/m2. Furthermore, the digitizer 114B may be further communicatively coupled to the computer 116 through the network 106B (interchangeably used an ethernet). Furthermore, the bias tee 502 may be used to insert a direct current (DC) power into an alternate current (AC) signal to power remote antenna amplifiers, and other similar devices. Furthermore, the bias tee 502 may usually be positioned at a receiving end of the coaxial cable to pass DC power from an external source to the coaxial cable running to powered device.

Assuming the characteristics of system 100 in equations 4 and 5, the system 100 may calculate an effective aperture of the horn antenna 110 in equation 6.

$${G}_{a n t} = 10 dBi , {G}_{L N B} = 60 dBi = 0.7 dB , {T}_{s y s} = 50.7 K \qquad ( 5 )$$

In Equation 7, the system 100 may use a power flux density to estimate power received at the antenna 110, which may account for a 3 dB polarization mismatch loss due to the circular polarization of the downlink signal and the linear polarization of the horn antenna 110 of the system 100.

$${P}_{R} = {FA}_{e} = - 1 30.4 dBW - 3 dB = - 133.4 dBW \qquad ( 7 )$$

In Equation 8, the system 100 may use the information along with Boltzmann's constant to calculate the carrier-to-noise ratio (C/N) at the receiver 108 of the system 100.

$$\frac{C}{N} [ dB ] = {P}_{R} - k - {T}_{s y s} - {B}_{N} = 18.1 dB \qquad ( 8 )$$

Further, the noise temperature of the system 100 may be equal to the noise temperature of the LNB 114A. Furthermore, the noise figure of the USRP clock may be negligible due to the high gain of the LNB 114A. A C/N over 18 dB may indicate that the system 100 may obtain a plurality of useful signals above a noise floor even when the antenna 110 used may include a lower-gain antenna.

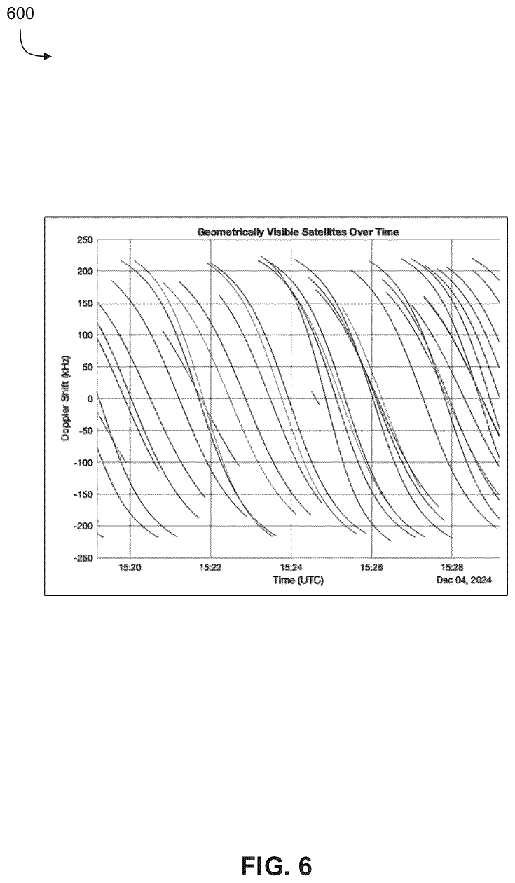

FIG. 6 illustrate an example graphical representation 600 of a unique doppler shifts due to geometrically visible satellites of the system 100, according to an example. According to FIG. 6, center of a radio frequency (RF) channel of interest may be, for example, but not limited to, 11.325 GHz. Further, the center of the RF of interest of the system 100 may be for example, but not limited to, 11.3248 GHz. Furthermore, the system 100 may observe 1 MHz of bandwidth, which beacon tones may sit within. Further, there may be 9 tones, which may be separated by 44 kHz each, the beacon tones only occupy 396 kHz of the bandwidth. Additionally, the beacon tones may experience a high Doppler shift of 230 kHz, such that the beacon tones may appear anywhere in the bandwidth before Doppler compensation. Furthermore, the LNB 114A has a local oscillator frequency of 10 GHz, thereby the Ku-band center frequency may be mixed down to the L-band intermediate frequency of 1.3248 GHz. Therefore, a center frequency in the USRP clock of the system 100 may be 1.3248 GHz. Furthermore, the USRP clock may be a direct conversion receiver, there may be a large peak at center frequency of the system 100 due to LO leakage.

In an example, the system 100 may use a frequency offset of 500 kHz to place this at the bottom of desired bandwidth of the system 100. Further, the system 100 may use a sample rate of 2 Msps to satisfy the Nyquist criterion. Furthermore, the USRP clock always samples at master clock rate of 200 Msps. Furthermore, the system 100 may decimate by a factor of 100 to achieve desired sample rate. For an instance, a 20-millisecond FFTs may be ideal for capturing a frequency content of the beacon tones without Doppler spreading the frequency content across too many bins.

Additionally, on a signal processing side, the first challenge may be of isolating the beacon tones simultaneously received from different satellites.

Further, the system 100 may simulate the plurality of Starlink satellites, which may be geometrically visible at any given time and then identify unique Doppler shifts of the plurality of Starlink satellites. Furthermore, the unique Doppler shifts may be used to identify from which satellites the system 100 may actually receive beacon tones from. Furthermore, the beacon tones for each particular satellite may be separated by exactly 44 kHz, which may be helpful for separating received signals.

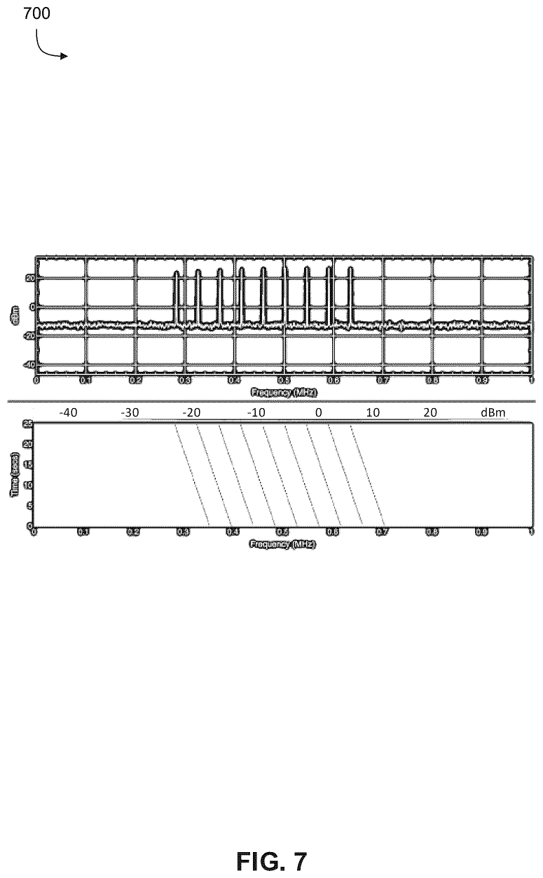

FIG. 7 illustrates an example graphical representation 700 of MATLAB simulation of signal with doppler frequency drift due to movement of the at least one satellite 102, according to an example. According to FIG. 7, to identify the Doppler shift of a set of the beacon tones from a given satellite, the Short Time Fourier Transform (STFT) of time domain signal may be taken in 20-millisecond chunks to track the movement of the peaks in the frequency domain over time. STFT enables tracking of frequency drift caused by satellite motion by producing a time-frequency spectrogram. Furthermore, the resulting Doppler trace, visualized as a drifting peak, can then be compared to predicted Doppler profiles for satellite identification. The STFT works by dividing the input signal into overlapping time windows (e.g., 20 millisecond each), applying a window function to each segment, and then computing the Fourier Transform over each window. This process generates a 2D spectrogram that reveals how the frequency content of the signal evolves over time. In the context of Doppler tracking, the STFT allows the system to observe frequency drifts introduced by satellite motion, making it especially suitable for detecting non-stationary tones in beacon signals. A MATLAB simulation illustrates this by generating a tone with frequency linearly drifting over time and visualizing the Doppler trend using STFT-based spectrogram. Further, the doppler shift may be compared to the potential Doppler shifts to determine satellite identity. Furthermore, FIG. 7 provides the Doppler shifts of peaks in a simulated signal.

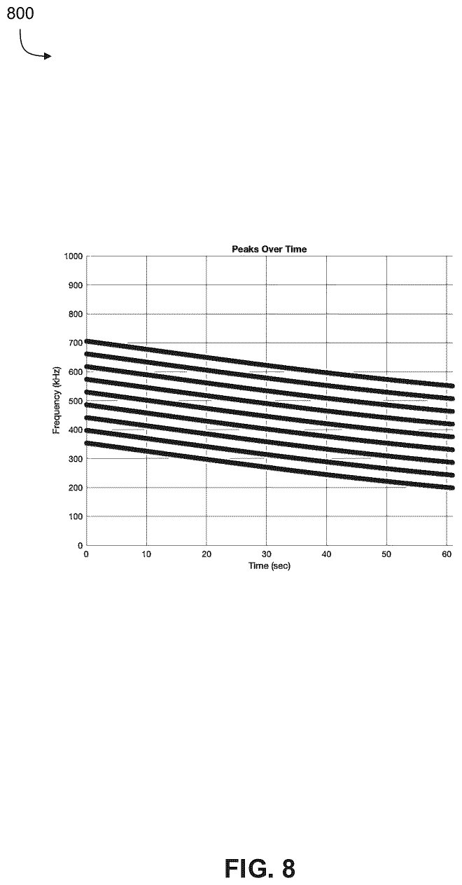

FIG. 8 illustrates an example graphical representation 800 of extraction of peak information from the plurality of signals for Doppler identification of the system 100, according to an example. According to FIG. 8, specific peaks may have been extracted from a downlink signal. Further, almost 7,000 Starlink satellites may be present in orbit, therefore around 30-40 Starlink satellites may be geometrically visible at any given time. Furthermore, the geometrically visible may mean that the Starlink satellites may be above a minimum elevation angle of 30 degrees. However, the system 100 may expect to receive signals from 3-4 satellites at a time due to the manner in which the satellites target specific regions of illumination on the ground. Further, a satellite being geometrically visible, may not mean that the satellite may be pointing beam of the satellite. Furthermore, the set of beacon tones as soon as corresponding to a specific satellite may be identified, the Doppler effect may be compensated for.

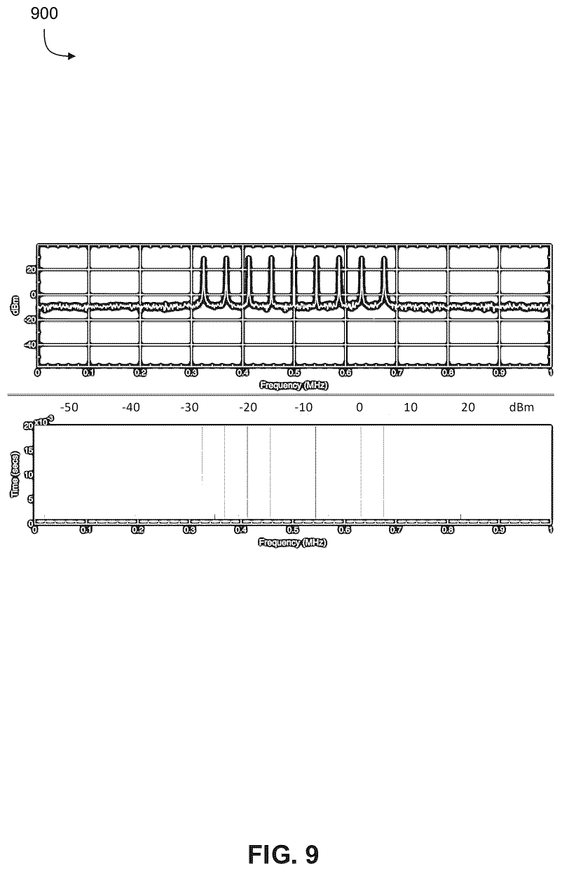

FIG. 9 illustrates an example graphical representation 900 of MATLAB simulation of received signal after Doppler compensation of the system 100, according to an example. Further, the forward scatter phenomenon may be caused by the airborne object 104 including but not limited to a drone, which may be flying through line of transmission. Furthermore, the line of transmission may have two effects on the signal including but not limited to amplitude fluctuations and an additional Doppler shift. Furthermore, the forward scatter gain may be an inverse gain and may significantly decrease the amplitude of the signal. Furthermore, the forward scattering gain when the drone may cross the baseline may be seen in Equation 9, while the gain as a function of angle may be seen in Equation 10, where A may be the cross-sectional area of the drone and lambda may be the wavelength:

$$G = \frac{4 π A}{{λ}^{2}} \qquad ( 9 )$$

$$G ( θ ) = {G ( \frac{λsin ( \frac{θ π \sqrt{A}}{λ} )}{θ π \sqrt{A}} )}^{2} \qquad ( 10 )$$

Further, additional Doppler shift may depend on the motion of the drone relative to the receiver 108 and may be used to estimate the velocity of the drone. Furthermore, the drone may form a V shape on the spectrogram, which may reach 0 Hz as the drone may cross the baseline. Furthermore, this may be a reliable factor in detecting present of the drone. Furthermore, the rotating blades of the drone also may produce small, higher-frequency micro-Doppler effects, which may be used to distinguish the drone from other flying objects, including but not limited to birds. Furthermore, the Doppler and micro-Doppler effects may be simulated in MATLAB, a model may be trained on signatures obtained from experimental data. This involves collecting labeled Doppler spectrograms or extracted features from known objects (e.g., drones, birds), then training a machine learning model such as, for example, but not limited to, a convolutional neural network (CNN) or support vector machine (SVM) to recognize distinct motion and micro-motion signatures. The trained model can then classify unknown signals based on learned patterns in time-frequency space, providing a robust means of distinguishing target drones from other airborne objects.

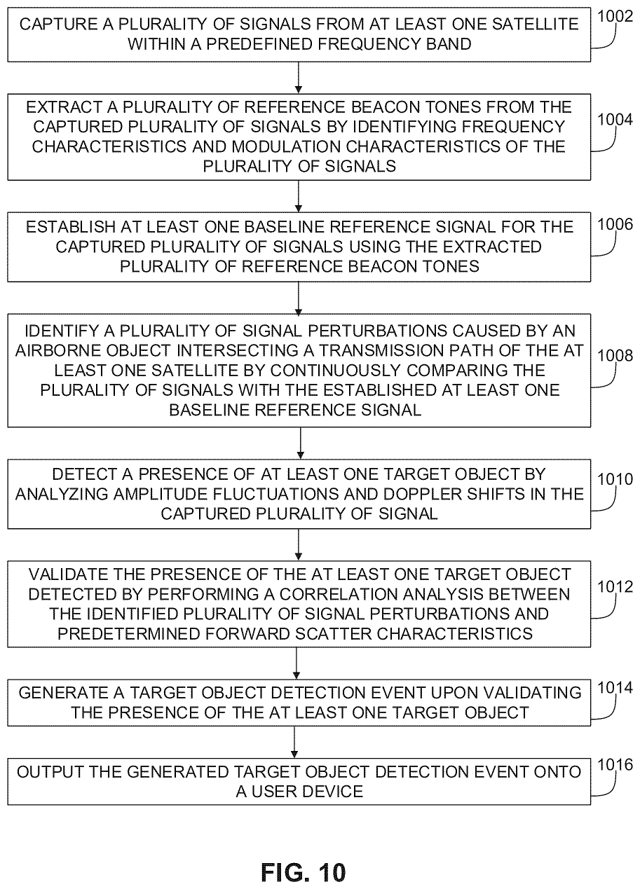

FIG. 10 illustrates an example flow diagram representation of a method 1000 to detect airborne intrusions using signals from low Earth orbit (LEO) satellites, according to an example. The disclosed method 1000 may be performed by one or more components of the receiver 108 disclosed herein. For example, with reference to FIG. 2, the steps disclosed herein may be performed by the signal processing unit 112 (interchangeably used as the processor).

At block 1002, the method 1000 may include capturing, by the antenna 110 of the communication system 100, a plurality of signals from the at least one satellite 102 within a predefined frequency band, wherein the plurality of signals comprises downlink signals. In an example, the at least one satellite 102 may comprise a Low Earth Orbit (LEO) satellite.

At block 1004, the method 1000 may include extracting, by the processor 112 of the communication system 100, a plurality of reference beacon tones from the captured plurality of signals by identifying frequency characteristics and modulation characteristics of the plurality of signals.

At block 1006, the method 1000 may include establishing, by the processor 112 of the communication system 100, at least one baseline reference signal for the captured plurality of signals using the extracted plurality of reference beacon tones.

At block 1008, the method 1000 may include identifying, by the processor 112 of the communication system 100, a plurality of signal perturbations caused by the airborne object 104 intersecting a transmission path of the at least one satellite 102 by continuously comparing the plurality of signals with the established at least one baseline reference signal.

At block 1010, the method 1000 may include detecting, by the processor 112 of the communication system 100, a presence of at least one target object by analyzing amplitude fluctuations and doppler shifts in the captured plurality of signals. In an example, the at least one target object corresponds to a type of the airborne object 104.

At block 1012, the method 1000 may include validating, by the processor 112 of the communication system 100, the presence of the at least one target object detected by performing a correlation analysis between the identified plurality of signal perturbations and predetermined forward scatter characteristics.

At block 1014, the method 1000 may include generating, by the processor 112 of the communication system 100, a target object detection event upon validating the presence of the at least one target object.

At block 1016, the method 1000 may include outputting, by the processor 112 of the communication system 100, the generated target object detection event onto a user device 116. In an example, the target object detection event may indicate target object characteristics.

In an example, the method 1000 may include down converting, by the frequency down converter unit 114A of the communication system 100, a frequency of the captured plurality of signals to intermediate frequency signals. Further, the method 1000, may include down sampling, by the sampling unit 114B of the communication system 100, the intermediate frequency signals at a predetermined rate to generate sampled signals.

In an example, the method 1000 may include synchronizing, by the reference oscillator 114C of the communication system 100, clocks of the frequency down converter unit 114A and the sampling unit 114B with an external GPS oscillator.

In an example, the method 1000 may include extracting, by the processor 112 of the communication system 100, the plurality of reference beacon tones from the captured plurality of signals by identifying frequency characteristics and modulation characteristics of the plurality of signals. Further, the method 1000 may include, extracting, by the processor 112 of the communication system 100 the plurality of reference beacon tones separated by a specific spacing within a reference signal bandwidth of the captured plurality of signals. Furthermore, the method 1000 may include, compensating, by the processor 112 of the communication system 100, doppler shifts caused by a satellite motion using Short Time Fourier Transform (STFT) analysis by applying a frequency correction model.

In an example, the method 1000 may include, identifying, by the processor 112 of the communication system 100, the plurality of signal perturbations caused by the airborne object 104 intersecting the transmission path of the at least one satellite 102. Further, the method 1000 may include, detecting, by the processor 112 of the communication system 100, a plurality of fluctuations in the plurality of reference beacon tones indicative of forward scatter effects caused by the airborne object 104 crossing a line-of-sight path between the at least one satellite 102 and the antenna 110. Furthermore, the plurality of fluctuations may include amplitude fluctuations. Furthermore, the method 1000 may include, computing, by the processor 112 of the communication system 100, doppler shifts in the plurality of reference beacon tones based on the detected plurality of fluctuations. Furthermore, the doppler shifts may be computed by computing frequency shifts over time using Fast Fourier Transform (FFT) and Short Time Fourier Transform (STFT) methods. Furthermore, the method 1000 may include, identifying, by the processor 112 of the communication system 100, the plurality of signal perturbations caused by the airborne object 104 intersecting the transmission path of the at least one satellite 102 based on the computed doppler shifts.

In an example the method 1000 may include, detecting, by the processor 112 of the communication system 100, the presence of the at least one target object by analyzing the amplitude fluctuations and the doppler shifts in the captured plurality of signals. Further, the method 1000 may include, identifying, by the processor 112 of the communication system 100, an additional doppler shift component forming a V-shaped signature in a spectrogram. Furthermore, the additional doppler shift component may indicate a presence of the at least one target object. Furthermore, estimating, by the processor 112 of the communication system 100, a velocity value, and a trajectory data of the at least one target object relative to the established at least one baseline reference signal based on the identified additional doppler shift component.

In an example, the method 1000 may include validating, by the processor 112 of the communication system 100, the presence of the at least one target object detected by performing the correlation analysis between the identified plurality of signal perturbations and predetermined forward scatter characteristics. Further, the method 1000 may include, isolating, by the processor 112 of the communication system 100, a specific-frequency micro-doppler fluctuations superimposed on a primary Doppler shift signal. Furthermore, the method 1000 may include, identifying, by the processor 112 of the communication system 100, a plurality of frequency modulations caused by rotating object propellers to distinguish the at least one target object from other airborne objects. In an example, the other airborne objects may be, for example, birds, or other obstacles. Furthermore, the method 1000 may include, determining, by the processor 112 of the communication system 100, a type of the airborne object 104 by correlating the isolated specific-frequency micro-doppler fluctuations with a pre-trained classification model. Furthermore, validating, by the processor 112 of the communication system 100, the presence of the at least one target object detected based on the determined type of the airborne object 104.

Additionally, the method 1000 may include, outputting, by the processor 112 of the communication system 100, the generated target object detection event onto the user device 116. Furthermore, the method 1000 may include, generating, by the processor 112 of the communication system 100, real-time alerts indicating the generated target object detection event. In an example, the alerts may include an intrusion alert, a proximity alert, an altitude alert, a collision risk alert, a jamming alert, and an GPS (Global Positioning System) spoofing alert. Further, the intrusion alert may be triggered when the airborne object 104 may enter restricted zone including but not limited to airports and military bases. Furthermore, the proximity alert may alert the user when the airborne object 104 may come close to a sensitive area. Furthermore, the altitude alert may notify when the airborne object 104 may go beyond a certain altitude threshold. Furthermore, the collision risk alert may warn when the airborne object 104 may be on a potential collision course with for example but not limited to another aircraft and object. Furthermore, the jamming alert may be triggered when a control signal may be suspected to be jammed. Furthermore, the GPS spoofing alert may notify when data of the airborne object 104 may appear to be false. Further, the method 1000 may include, displaying, by the processor 112 of the communication system 100, the generated real-time alerts on a graphical interface of the user device 116.

In an example, the method 1000 may include, identifying, by the processor 112 of the communication system 100, a subset of satellites transmitting the plurality of reference beacon tones from among a set of geometrically visible satellites above a predefined elevation angle. Further, the method 1000 may include, determining, by the processor 112 of the communication system 100, beam coverage patterns associated with the identified subset of satellites. Furthermore, the method 1000 may include selecting, by the processor 112 of the communication system 100, appropriate at least one satellite 102 from among the identified subset of satellites based on the determined beam coverage patterns. Furthermore, the appropriate at least one satellite 102 actively transmits the plurality of reference beacon tones towards a detection area.

In an example, the method 1000 may include, computing, by the processor 112 of the communication system 100, a forward scatter gain using a set of parameters. Further, the set of parameters comprise a wavelength of a downlink frequency, a cross-sectional area of the at least one target object, and a linear dimension of the at least one target object. Furthermore, the method 1000 may include computing, by the processor 112 of the communication system 100, an apparent Radar Cross-Section (RCS) value of the at least one target object based on the computed forward scatter gain.

The order in which the method 1000 is described is not intended to be construed as a limitation, and any number of the described method blocks may be combined or otherwise performed in any order to implement the method 1000 or an alternate method. Additionally, individual blocks may be deleted from the method 1000 without departing from the spirit and scope of the ongoing description. Furthermore, the method 1000 may be implemented in any suitable hardware, software, firmware, or a combination thereof, that exists in the related art or that is later developed. The method 1000 describes, without limitation, the implementation of the user device 116. A person of skill in the art will understand that method 1000 may be modified appropriately for implementation in various manners without departing from the scope and spirit of the ongoing description.

Various examples of systems and methods for detecting airborne intrusions using a plurality of downlink signals from low earth orbit (LEO) satellites, may be provided. Various example implementations of the disclosed approach herein may provide systems and methods for successfully receiving beacon signals from multiple LEO satellites, specifically at a time for localization purposes.

Various examples of systems and methods for detecting airborne intrusions using a plurality of downlink signals from low earth orbit (LEO) satellites, may be provided. Various example implementations of the disclosed approach herein may provide that although the primary function of the beacon tones is to facilitate satellite identification, the correlation between the unique identifiers and the corresponding satellites may not be known to the public. Nevertheless, the ephemerides of all the plurality of Starlink satellites at any specific moment may be accessible to the public.

Various examples of systems and methods for detecting airborne intrusions using a plurality of downlink signals from low earth orbit (LEO) satellites, may be provided. Various example implementations of the disclosed approach herein may provide that the system may also require less hardware complexity, as only one receiver may be necessary because the system may look for certain fluctuations in the reference signal, and a narrow bandwidth may be used because range compression may not be a constraint. Due to abovementioned reasons, forward scatter passive radar may be better.

Various examples of systems and methods for detecting airborne intrusions using a plurality of downlink signals from low earth orbit (LEO) satellites, may be provided. Various example implementations of the disclosed approach herein may provide an alternative solution, for localization purposes, which may be much simpler and may take advantage of ability of the system 100 to use only a narrow bandwidth. Further, this may involve using a static horn antenna with lower gain and directivity than a phased array to receive the simple 1-MHz bandwidth beacon tones from the plurality of Starlink satellites at a time. Thus, the system 100 of present invention using the static antenna greatly reduce cost and complexity. Additionally, the system of present invention may also allow for drone detection across multiple satellite links at a time.

Various examples of the system 100 may be provided, the system 100 may be a passive radar detection system using Starlink satellite signals as illuminators. The system 100 may include a receiver 108, which may capture the signals and differentiate between raw signals coming directly from the Starlink satellites and the perturbed signal due to flying the airborne object 104 between the receiver 108 and the satellites.

One of ordinary skill in the art will appreciate that techniques consistent with the ongoing description are applicable in other contexts as well without departing from the scope of the ongoing description.

As mentioned above, what is shown and described with respect to the systems and methods above are illustrative. While examples described herein are directed to configurations as shown, it should be appreciated that any of the components described or mentioned herein may be altered, changed, replaced, or modified, in size, shape, and numbers, or material, depending on application or use case, and adjusted for managing network communication.

It should also be appreciated that the systems and methods, as described herein, may also include, or communicate with other components not shown. For example, these may include external processors, counters, analyzers, computing devices, and other measuring devices or systems. This may also include middleware (not shown) as well. The middleware may include software hosted by one or more servers or devices. Furthermore, it should be appreciated that some of the middleware or servers may or may not be needed to achieve functionality. Other types of servers, middleware, systems, platforms, and applications not shown may also be provided at the back end to facilitate the features and functionalities of the testing and measurement system.

Moreover, single components may be provided as multiple components, and vice versa, to perform the functions and features described herein. It should be appreciated that the components of the system described herein may operate in partial or full capacity, or it may be removed entirely. It should also be appreciated that analytics and processing techniques described herein with respect to the optical measurements, for example, may also be performed partially or in full by other various components of the overall system.

It should be appreciated that data stores may also be provided to the apparatuses, systems, and methods described herein, and may include volatile and/or nonvolatile data storage that may store data and software or firmware including machine-readable instructions. The software or firmware may include subroutines or applications that perform the functions of the measurement system and/or run one or more application that utilize data from the measurement or other communicatively coupled system.

The various components, circuits, elements, components, and interfaces may be any number of mechanical, electrical, hardware, network, or software components, circuits, elements, and interfaces that serves to facilitate communication, exchange, and analysis data between any number of or combination of equipment, protocol layers, or applications. For example, the components described herein may each include a network or communication interface to communicate with other servers, devices, components or network elements via a network or other communication protocol.

It should be appreciated that the systems and methods described herein may also be used to help provide, directly or indirectly, measurements for distance, angle, rotation, speed, position, wavelength, transmissivity, and/or other related tests and measurements.

What has been described and illustrated herein are examples of the implementation along with some variations. The terms, descriptions, and figures used herein are set forth by way of illustration only and are not meant as limitations. Many variations are possible within the scope of the implementations, which is intended to be defined by the following claims—and their equivalents—in which all terms are meant in their broadest reasonable sense unless otherwise indicated.

1. A system comprising:
an antenna to:
capture a plurality of signals from at least one satellite within a predefined frequency band, wherein the plurality of signals comprises downlink signals and wherein the at least one satellite comprises a Low Earth Orbit (LEO) satellite;
a signal processing unit to:
extract a plurality of reference beacon tones from the captured plurality of signals by identifying frequency characteristics and modulation characteristics of the plurality of signals;
establish at least one baseline reference signal for the captured plurality of signals using the extracted plurality of reference beacon tones;
identify a plurality of signal perturbations caused by an airborne object intersecting a transmission path of the at least one satellite by continuously comparing the plurality of signals with the established at least one baseline reference signal;
detect a presence of at least one target object by analyzing amplitude fluctuations and doppler shifts in the captured plurality of signals, wherein the at least one target object corresponds to a type of the airborne object;
validate the presence of the at least one target object detected by performing a correlation analysis between the identified plurality of signal perturbations and predetermined forward scatter characteristics;
generate a target object detection event upon validating the presence of the at least one target object; and
output the generated target object detection event onto a user device, wherein the target object detection event indicates target object characteristics.

2. The system of claim 1, further comprising:
a signal conditioning unit communicatively coupled to the antenna, wherein the signal conditioning unit comprises:
a frequency down converter unit to down convert a frequency of the captured plurality of signals to intermediate frequency signals; and
a sampling unit to sample the intermediate frequency signals at a predetermined rate to generate sampled signals.

3. The system of claim 2, further comprising:
a reference oscillator to synchronize clocks of the frequency down converter unit and the sampling unit with an external GPS oscillator.

4. The system of claim 1, wherein to extract the plurality of reference beacon tones from the captured plurality of signals by identifying frequency characteristics and modulation characteristics of the plurality of signals, the signal processing unit is to:
extract the plurality of reference beacon tones separated by a specific spacing within a reference signal bandwidth of the captured plurality of signals; and
compensate doppler shifts caused by a satellite motion using Short Time Fourier Transform (STFT) analysis by applying a frequency correction model.

5. The system of claim 1, wherein to identify the plurality of signal perturbations caused by the airborne object intersecting the transmission path of the at least one satellite, the signal processing unit is to:
detect a plurality of fluctuations in the plurality of reference beacon tones indicative of forward scatter effects caused by the airborne object crossing a line-of-sight path between the at least one satellite and the antenna, wherein the plurality of fluctuations comprise amplitude fluctuations;
compute doppler shifts in the plurality of reference beacon tones based on the detected plurality of fluctuations, wherein the doppler shifts are computed by computing frequency shifts over time using Fast Fourier Transform (FFT) and Short Time Fourier Transform (STFT) methods; and
identify the plurality of signal perturbations caused by the airborne object intersecting the transmission path of the at least one satellite based on the computed doppler shifts.

6. The system of claim 1, wherein to detect the presence of the at least one target object by analyzing the amplitude fluctuations and the doppler shifts in the captured plurality of signals, the signal processing unit is to:
identify an additional doppler shift component forming a V-shaped signature in a spectrogram, wherein the additional doppler shift component indicates a presence of the at least one target object; and
estimate a velocity value and a trajectory data of the at least one target object relative to the established at least one baseline reference signal based on the identified additional doppler shift component.

7. The system of claim 1, wherein to validate the presence of the at least one target object detected by performing the correlation analysis between the identified plurality of signal perturbations and predetermined forward scatter characteristics, the signal processing unit is to:
isolate a specific-frequency micro-doppler fluctuations superimposed on a primary Doppler shift signal;
identify a plurality of frequency modulations caused by rotating object propellers to distinguish the at least one target object from other airborne objects;
determine a type of the airborne object by correlating the isolated specific-frequency micro-doppler fluctuations with a pre-trained classification model; and
validate the presence of the at least one target object detected based on the determined type of the airborne object.

8. The system of claim 1, wherein to output the generated target object detection event onto the user device, the signal processing unit is to:
generate real-time alerts indicating the generated target object detection event; and
display the generated real-time alerts on a graphical interface of the user device.

9. The system of claim 1, wherein the signal processing unit is further to:
identify a subset of satellites transmitting the plurality of reference beacon tones from among a set of geometrically visible satellites above a predefined elevation angle;
determine beam coverage patterns associated with the identified subset of satellites; and
select appropriate at least one satellite from among the identified subset of satellites based on the determined beam coverage patterns, wherein the appropriate at least one satellite actively transmits the plurality of reference beacon tones towards a detection area.

10. The system of claim 1, wherein the signal processing unit is further to:
compute a forward scatter gain using a set of parameters, wherein the set of parameters comprise a wavelength of a downlink frequency, a cross-sectional area of the at least one target object, and a linear dimension of the at least one target object; and
compute an apparent Radar Cross-Section (RCS) value of the at least one target object based on the computed forward scatter gain.

11. A method comprising:
capturing, by an antenna of a communication system, a plurality of signals from at least one satellite within a predefined frequency band, wherein the plurality of signals comprises downlink signals and wherein the at least one satellite comprises a Low Earth Orbit (LEO) satellite;
extracting, by a processor of the communication system, a plurality of reference beacon tones from the captured plurality of signals by identifying frequency characteristics and modulation characteristics of the plurality of signals;
establishing, by the processor of the communication system, at least one baseline reference signal for the captured plurality of signals using the extracted plurality of reference beacon tones;
identifying, by the processor of the communication system, a plurality of signal perturbations caused by an airborne object intersecting a transmission path of the at least one satellite by continuously comparing the plurality of signals with the established at least one baseline reference signal;
detecting, by the processor of the communication system, a presence of at least one target object by analyzing amplitude fluctuations and doppler shifts in the captured plurality of signals, wherein the at least one target object corresponds to a type of the airborne object;
validating, by the processor of the communication system, the presence of the at least one target object detected by performing a correlation analysis between the identified plurality of signal perturbations and predetermined forward scatter characteristics;
generating, by the processor of the communication system, a target object detection event upon validating the presence of the at least one target object; and
outputting, by the processor of the communication system, the generated target object detection event onto a user device, wherein the target object detection event indicates target object characteristics.

12. The method of claim 11, further comprising:
down converting, by a frequency down converter unit of the communication system, a frequency of the captured plurality of signals to intermediate frequency signals; and
sampling, by a sampling unit of the communication system, the intermediate frequency signals at a predetermined rate to generate sampled signals.

13. The method of claim 12, further comprising:
synchronizing, by a reference oscillator of the communication system, clocks of the frequency down converter unit and the sampling unit with an external GPS oscillator.

14. The method of claim 11, wherein extracting the plurality of reference beacon tones from the captured plurality of signals by identifying frequency characteristics and modulation characteristics of the plurality of signals comprises:
extracting, by the processor of the communication system, the plurality of reference beacon tones separated by a specific spacing within a reference signal bandwidth of the captured plurality of signals; and
compensating, by the processor of the communication system, doppler shifts caused by a satellite motion using Short Time Fourier Transform (STFT) analysis by applying a frequency correction model.

15. The method of claim 11, wherein identifying the plurality of signal perturbations caused by the airborne object intersecting the transmission path of the at least one satellite comprises:
detecting, by the processor of the communication system, a plurality of fluctuations in the plurality of reference beacon tones indicative of forward scatter effects caused by the airborne object crossing a line-of-sight path between the at least one satellite and the antenna, wherein the plurality of fluctuations comprise amplitude fluctuations;
computing, by the processor of the communication system, doppler shifts in the plurality of reference beacon tones based on the detected plurality of fluctuations, wherein the doppler shifts are computed by computing frequency shifts over time using Fast Fourier Transform (FFT) and Short Time Fourier Transform (STFT) methods; and
identifying, by the processor of the communication system, the plurality of signal perturbations caused by the airborne object intersecting the transmission path of the at least one satellite based on the computed doppler shifts.

16. The method of claim 11, wherein detecting the presence of the at least one target object by analyzing the amplitude fluctuations and the doppler shifts in the captured plurality of signals comprises:
identifying, by the processor of the communication system, an additional doppler shift component forming a V-shaped signature in a spectrogram, wherein the additional doppler shift component indicates a presence of the at least one target object; and
estimating, by the processor of the communication system, a velocity value, and a trajectory data of the at least one target object relative to the established at least one baseline reference signal based on the identified additional doppler shift component.

17. The method of claim 11, wherein validating the presence of the at least one target object detected by performing the correlation analysis between the identified plurality of signal perturbations and predetermined forward scatter characteristics comprises:
isolating, by the processor of the communication system, a specific-frequency micro-doppler fluctuations superimposed on a primary Doppler shift signal;
identifying, by the processor of the communication system, a plurality of frequency modulations caused by rotating object propellers to distinguish the at least one target object from other airborne objects;
determining, by the processor of the communication system, a type of the airborne object by correlating the isolated specific-frequency micro-doppler fluctuations with a pre-trained classification model; and
validating, by the processor of the communication system, the presence of the at least one target object detected based on the determined type of the airborne object.

18. The method of claim 11, further comprising:
identifying, by the processor of the communication system, a subset of satellites transmitting the plurality of reference beacon tones from among a set of geometrically visible satellites above a predefined elevation angle;
determining, by the processor of the communication system, beam coverage patterns associated with the identified subset of satellites; and
selecting, by the processor of the communication system, appropriate at least one satellite from among the identified subset of satellites based on the determined beam coverage patterns, wherein the appropriate at least one satellite actively transmits the plurality of reference beacon tones towards a detection area.

19. The method of claim 11, further comprising:
computing, by the processor of the communication system, a forward scatter gain using a set of parameters, wherein the set of parameters comprise a wavelength of a downlink frequency, a cross-sectional area of the at least one target object, and a linear dimension of the at least one target object; and
computing, by the processor of the communication system, an apparent Radar Cross-Section (RCS) value of the at least one target object based on the computed forward scatter gain.

20. A non-transitory computer readable medium comprising a processor-executable instructions that cause a processor to:
capture a plurality of signals from at least one satellite within a predefined frequency band, wherein the plurality of signals comprise downlink signals and wherein the at least one satellite comprises a Low Earth Orbit (LEO) satellite;
extract a plurality of reference beacon tones from the captured plurality of signals by identifying frequency characteristics and modulation characteristics of the plurality of signals;
establish at least one baseline reference signal for the captured plurality of signals using the extracted plurality of reference beacon tones;
identify a plurality of signal perturbations caused by an airborne object intersecting a transmission path of the at least one satellite by continuously comparing the plurality of signals with the established at least one baseline reference signal;
detect a presence of at least one target object by analyzing amplitude fluctuations and doppler shifts in the captured plurality of signals, wherein the at least one target object corresponds to a type of the airborne object;
validate the presence of the at least one target object detected by performing a correlation analysis between the identified plurality of signal perturbations and predetermined forward scatter characteristics;
generate a target object detection event upon validating the presence of the at least one target object; and
output the generated target object detection event onto a user device, wherein the target object detection event indicates target object characteristics.
